(19) United States
(12) Patent Application Publication
(10) Pub. No.: US 2022/0256220 A1
(43) Pub. Date: Aug. 11, 2022

(54) INFORMATION PROCESSING APPARATUS AND INFORMATION PROCESSING METHOD

(71) Applicant: SONY GROUP CORPORATION, TOKYO (JP)

(72) Inventors: HIDEAKI MIYAHARA, TOKYO (JP); MASAHIKO SATO, TOKYO (JP)

(21) Appl. No.: 17/597,534

(22) PCT Filed: Jul. 3, 2020
(86) PCT No.: PCT/JP2020/026171

§ 371 Date: Jan. 10, 2022

(30) Foreign Application Priority Data
Jul. 19, 2019 (JP) 2019-133696

(51) Int. Cl. H04N 21/266; H04N 21/258

(52) U.S. Cl. CPC H04N 21/266; H04N 21/25866

(57) ABSTRACT

The present technology relates to an information processing apparatus and an information processing method that enable improvement of the convenience of a user. The convenience of the user can be improved by providing an information processing apparatus including a control unit that performs control to receive control information from a device associated with a network service and present presentation information regarding the network service designated by the control information on the basis of an identification result for a user who uses the device. The present technology can be applied to, for example, a television receiver.

### TECHNICAL FIELD

The present technology relates to an information processing apparatus and an information processing method and, more particularly, to an information processing apparatus and an information processing method enabled to improve the convenience of a user.

### BACKGROUND ART

Conventionally, various devices have been widely utilized as devices capable of reproducing content. Furthermore, various services are provided as services for distributing content. Therefore, there are a variety of methods for users to listen to and view content using the devices.

Patent Document 1 discloses a technology of accessing specific pay content linked with a user account on a device of a user and recommending registration or deletion of subscription of the specific content as a proposed listening and viewing method on the basis of statistical information contained in a report for the accessed content.

### CITATION LIST

### Patent Document

Patent Document 1: U.S. Pat. No. 9,954,739

### SUMMARY OF THE INVENTION

### Problems to be Solved by the Invention

Incidentally, when a user listens to and views content, convenience is required, but the conventional technologies including the technology disclosed in Patent Document 1 are not sufficient to provide the convenience, and it is required to improve the convenience of the user.

The present technology has been made in view of such a situation and is intended to enable improvement of the convenience of a user.

### Solutions to Problems

An information processing apparatus according to one aspect of the present technology is an information processing apparatus including a control unit that performs control to receive control information from a device associated with a network service and present presentation information regarding the network service designated by the control information on the basis of an identification result for a user who uses the device.

An information processing apparatus according to one aspect of the present technology is an information processing apparatus including a control unit that performs control to acquire identification information for identifying a user, generate control information for causing a process of presenting presentation information regarding a network service on a device associated with the network service to be performed, and send each of the control information and the identification information.

An information processing method according to one aspect of the present technology is an information processing method including performing, by an information processing apparatus, control to receive control information from a device associated with a network service and present presentation information regarding the network service designated by the control information on the basis of an identification result for a user who uses the device.

In the information processing apparatus and the information processing method according to one aspect of the present technology, control information is received from a device associated with a network service, and presentation information regarding the network service designated by the control information is presented on the basis of an identification result for a user who uses the device.

In the information processing apparatus according to one aspect of the present technology, control is performed to acquire identification information for identifying a user, generate control information for causing a process of presenting presentation information regarding a network service on a device associated with the network service to be performed, and send each of the control information and the identification information.

The information processing apparatus according to one aspect of the present technology may be an independent apparatus or an internal block constituting one apparatus.

### BRIEF DESCRIPTION OF DRAWINGS

FIG. 1 is a diagram illustrating an example of the configuration of an embodiment of an information processing system to which the present technology is applied.

FIG. 2 is a diagram illustrating an example of the configuration of an embodiment of an information processing apparatus to which the present technology is applied.

FIG. 3 is a diagram illustrating an example of the configuration of an embodiment of an information processing apparatus to which the present technology is applied.

FIG. 4 is a diagram illustrating an example of the configuration of an embodiment of an information processing apparatus to which the present technology is applied.

FIG. 5 is a diagram illustrating an example of the configuration of an embodiment of an information processing apparatus to which the present technology is applied.

FIG. 6 is a diagram illustrating an example of a configuration in a case where a device account is used.

FIG. 7 is a diagram illustrating an example of a configuration in a case where an application account is used.

FIG. 8 is a diagram illustrating an example of a configuration in a case where a plug-in identifier (ID) is used.

FIG. 9 is a diagram illustrating an example of management of accounts in a case where a plurality of users shares a device.

FIG. 10 is a flowchart explaining a flow of a first example of a content reproduction process.

FIG. 11 is a diagram illustrating a first example of a management table.

FIG. 12 is a flowchart explaining a flow of a second example of the content reproduction process.

FIG. 13 is a flowchart explaining a flow of a third example of the content reproduction process.

FIG. 14 is a diagram illustrating a second example of the management table.

FIG. 15 is a flowchart explaining a flow of a fourth example of the content reproduction process.

FIG. 16 is a diagram illustrating a third example of the management table.

FIG. 17 is a flowchart explaining a flow of a fifth example of the content reproduction process.

FIG. 18 is a diagram illustrating a fourth example of the management table.

FIG. 19 is a flowchart explaining a flow of a sixth example of the content reproduction process.

FIG. 20 is a flowchart explaining a flow of a learning process.

FIG. 21 is a diagram illustrating another example of the configuration of a content reproduction system to which the present technology is applied.

FIG. 22 is a diagram illustrating still another example of the configuration of the content reproduction system to which the present technology is applied.

FIG. 23 is a diagram illustrating an example of the configuration of a computer.

### MODE FOR CARRYING OUT THE INVENTION

Hereinafter, embodiments of the present technology will be described with reference to the drawings. Note that the description will be given in the following order.

1. Embodiments of Present Technology

2. Modifications

3. Configuration of Computer

<1. Embodiments of Present Technology>

(System Configuration)

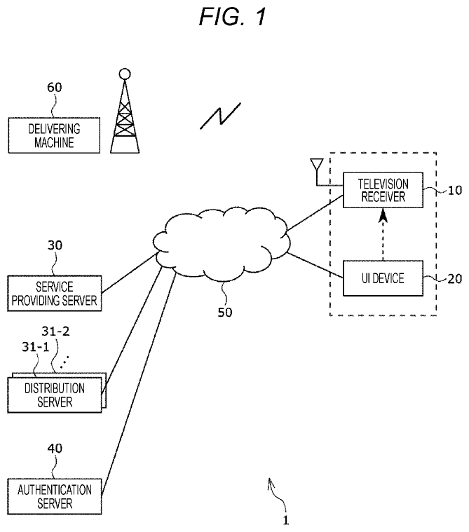

FIG. 1 illustrates an example of the configuration of a content reproduction system 1 as an embodiment of an information processing system to which the present technology is applied.

The content reproduction system 1 is constituted by a television receiver 10, a user interface (UI) device 20, a service providing server 30, distribution servers 31-1 to 31-N (N: an integer equal to or greater than one), and an authentication server 40.

Furthermore, in the content reproduction system 1, the television receiver 10 or the UI device 20 is interconnected with the service providing server 30, the distribution servers 31 to 31-N, or the authentication server 40 via a network 50. The network 50 includes communication networks such as the Internet, an intranet, and a mobile phone network.

The television receiver 10 is capable of receiving a broadcast signal sent from a delivering machine 60 via a radio tower or the like, via an antenna. The television receiver 10 processes the broadcast signal according to a user's tuning operation and outputs video and audio of broadcast content such as a television program.

Furthermore, the television receiver 10 has a communication function and is capable of receiving streaming data of communication content distributed from any of the distribution servers 31 to 31-N via the network 50. The television receiver 10 processes the streaming data according to a user's selection operation and outputs video and audio of the communication content such as a moving image.

The UI device 20 is a device having a predetermined user interface (UI), such as a smartphone, a mobile phone, a tablet terminal, a remote controller, a wearable device, a portable music player, a game machine, or a personal computer.

The UI device 20 makes various actions according to a user's operation on a predetermined user interface. For example, the UI device 20 instructs the television receiver 10 to reproduce the broadcast content or the communication content according to a user's operation.

Note that, although the television receiver 10 and the UI device 20 are used at the same place such as the user's home, the UI device 20 can be a mobile terminal carried and moved by the user, while the television receiver 10 is a fixed terminal situated at a predetermined position.

However, the present embodiment is not limited to this example, and instead of the television receiver 10, a smartphone, a tablet terminal, or the like that does not have a broadcast receiving function may be used, or a movable terminal such as one that is a part of a car navigation system may be used.

The service providing server 30 is constituted by one or a plurality of servers for providing services and is an external server situated in a data center or the like. The service providing server 30 provides a service for allowing the user to use a variety of network services (content services and the like) using various devices.

The distribution server 31-1 is constituted by one or a plurality of servers for distributing communication content and is an external server situated in a data center or the like. The distribution server 31-1 distributes the streaming data of communication content such as a moving image and music via the network 50 in response to a request from the television receiver 10 or the UI device 20.

Similarly to the distribution server 31-1, the distribution servers 31-2 to 31-N distribute the streaming data of communication content such as moving images via the network 50 in response to a request from the television receiver 10 or the UI device 20. Note that, in the following description, the distribution servers 31-1 to 31-N will be simply referred to as distribution servers 31 in a case where it is not particularly necessary to distinguish between the distribution servers 31-1 to 31-N.

The authentication server 40 is constituted by one or a plurality of servers for performing an authentication process for the user and is an external server situated in a data center or the like. The authentication server 40 performs the authentication process in response to a request from a device connected to the network 50, such as the UI device 20.

(Configuration of Television Receiver)

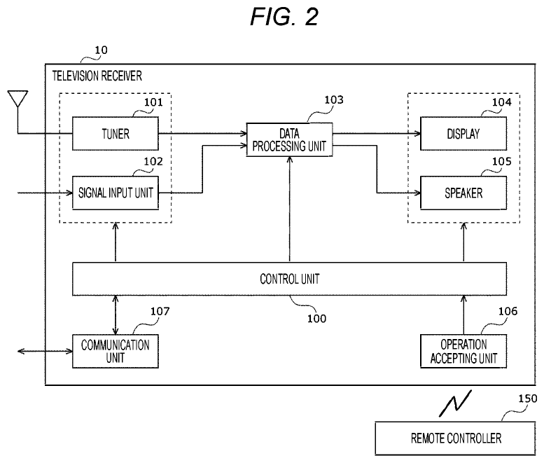

FIG. 2 illustrates an example of the configuration of the television receiver 10 in FIG. 1 as an embodiment of the information processing apparatus to which the present technology is applied.

In FIG. 2, the television receiver 10 is constituted by a control unit 100, a tuner 101, a signal input unit 102, a data processing unit 103, a display 104, a speaker 105, an operation accepting unit 106, and a communication unit 107.

The control unit 100 is constituted by a central processing unit (CPU), a microprocessor, or the like. The control unit 100 is a primary control apparatus (processing apparatus) that controls the action of each unit and performs various arithmetic processes and controls the action of each unit of the television receiver 10.

The tuner 101 performs processes such as a demodulation process on the broadcast signal received via the antenna and supplies a signal obtained as a result of the processes to the data processing unit 103. The broadcast signal here transmits broadcast content in accordance with a broadcasting approach such as terrestrial broadcasting, satellite broadcasting, or cable television broadcasting.

The signal input unit 102 is configured as an interface complying with a predetermined standard such as a high definition multimedia interface (HDMI (registered trademark)) or a universal serial bus (USB).

That is, a signal of recorded video content recorded as a video by a video recorder (video recorder/reproducer) or a network storage, recorded content recorded in a recording medium such as a semiconductor memory or an optical disc, or the like is input to the signal input unit 102 via an interface complying with a predetermined standard and supplied to the data processing unit 103.

The data processing unit 103 is constituted by a system on a chip (SoC) or the like. The data processing unit 103 performs processes such as decoding on the signal supplied from the tuner 101 or the signal input unit 102 and supplies video data obtained as a result of the processes to the display 104, while supplying audio data to the speaker 105.

For example, the display 104 is constituted by a liquid crystal display unit, an organic light emitting diode (OLED) display unit, or the like. The display 104 processes the video data supplied from the data processing unit 103 under the control of the control unit 100 and displays a video of broadcast content such as a television program, various screens, and the like.

The speaker 105 processes the audio data supplied from the data processing unit 103 under the control of the control unit 100 and outputs audio (sound) of broadcast content such as a television program.

The operation accepting unit 106 is constituted by, for example, a near-field wireless communication module, an infrared photodetection module, and the like. The operation accepting unit 106 receives (performs photodetection of) a signal such as a wireless signal or an infrared signal sent from a remote controller 150 and supplies the received signal to the control unit 100 as an operation signal.

The control unit 100 controls the action of each unit on the basis of a command according to the operation signal supplied from the operation accepting unit 106. Note that communication complying with a standard such as Bluetooth (registered trademark) can be performed as the near-field wireless communication. Furthermore, the UI device 20 may be used as the remote controller 150.

The communication unit 107 is constituted by a communication module or the like compatible with wireless communication or wired communication complying with a predetermined standard. The communication unit 107 communicates with another device via the network 50 under the control of the control unit 100. In addition, the communication unit 107 may communicate with another device such as the UI device 20 via a home network such as a wireless local area network (LAN) constructed in the user's home.

Specifically, the communication unit 107 requests the distribution server 31 to distribute communication content such as a moving image via the network 50 under the control of the control unit 100. The communication unit 107 receives the streaming data of the communication content distributed from the distribution server 31. This streaming data is supplied to the data processing unit 103 and subjected to processes such as decoding. Following this, video and audio of the communication content such as a moving image are output.

(Configuration of UI Device)

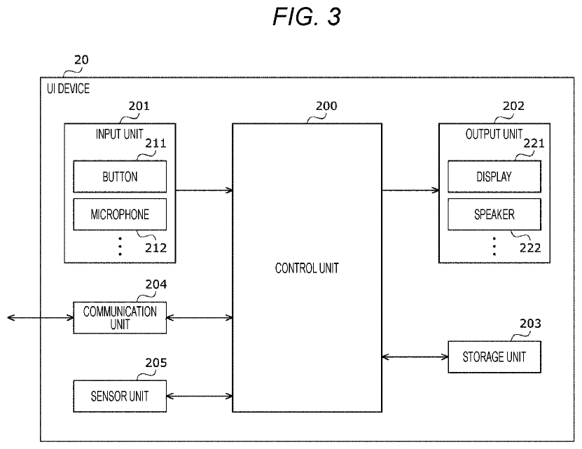

FIG. 3 illustrates an example of the configuration of the UI device 20 in FIG. 1 as an embodiment of the information processing apparatus to which the present technology is applied.

In FIG. 3, the UI device 20 is constituted by a control unit 200, an input unit 201, an output unit 202, a storage unit 203, a communication unit 204, and a sensor unit 205.

The control unit 200 is constituted by a processor such as a CPU. The control unit 200 is a primary control apparatus that controls the action of each unit and performs various arithmetic processes.

The input unit 201 is constituted by an input apparatus such as a physical button 211, a microphone 212, or a touch panel. The input unit 201 supplies an operation signal according to a user's operation to the control unit 200. The control unit 200 controls the action of each unit on the basis of the operation signal from the input unit 201.

The output unit 202 is constituted by an output apparatus such as a display 221 or a speaker 222. The output unit 202 outputs information according to various sorts of data under the control of the control unit 200.

The display 221 displays a video according to video data from the control unit 200. The speaker 222 outputs audio (sound) according to audio data from the control unit 200.

The storage unit 203 is constituted by a storage apparatus including a semiconductor memory such as a nonvolatile memory. The storage unit 203 stores various sorts of data under the control of the control unit 200.

The communication unit 204 is configured as a communication module compatible with wireless communication such as a wireless LAN, communication of a cellular approach (for example, long term evolution (LTE)-Advanced or Fifth Generation (5G)), or Bluetooth (registered trademark), or wired communication.

The communication unit 204 communicates with another device via the network 50 under the control of the control unit 200. Furthermore, the communication unit 204 may communicate with another device such as the television receiver 10 via a home network such as a wireless LAN constructed in the user's home.

Specifically, the communication unit 204 requests the distribution server 31 to distribute communication content such as a moving image via the network 50 under the control of the control unit 200. The communication unit 204 receives the streaming data of the communication content distributed from the distribution server 31. This streaming data is supplied to a data processing unit (not illustrated) and subjected to processes such as decoding. Following this, video and audio of the communication content such as a moving image are output.

The sensor unit 205 is constituted by various sensor devices and the like. The sensor unit 205 performs sensing of the user, the surroundings of the user, and the like and supplies sensing data obtained as a result of the sensing to the control unit 200.

Here, the sensor unit 205 can include: an acceleration sensor that measures acceleration; a gyro sensor that measures the angle (posture), angular velocity, and angular acceleration; a biometric sensor that measures information that an organism has, such as a heart rate, a body temperature, or a posture; a magnetic sensor that measures a magnitude and a direction of a magnetic field (area of magnetism); a proximity sensor that measures a proximity thing; and the like.

Note that, although not illustrated, a camera unit constituted by an optical system, an image sensor, a signal processing circuit, and the like may be provided to image a subject and supply imaging data obtained as a result of the imaging to the control unit 200. In the control unit 200, various processes are performed on the basis of the imaging data from the camera unit.

(Configuration of Service Providing Server)

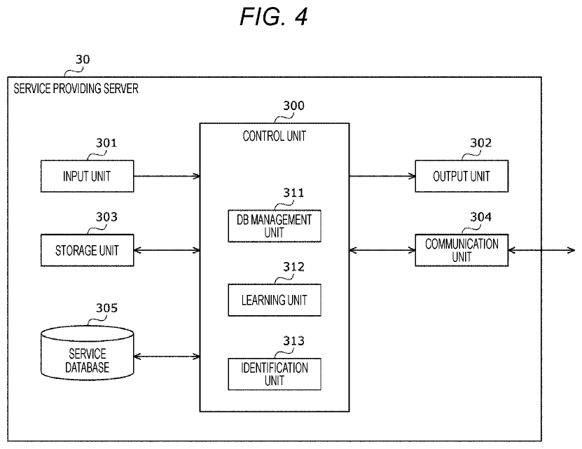

FIG. 4 illustrates an example of the configuration of the service providing server 30 in FIG. 1 as an embodiment of the information processing apparatus to which the present technology is applied.

In FIG. 4, the service providing server 30 is constituted by a control unit 300, an input unit 301, an output unit 302, a storage unit 303, a communication unit 304, and a service database 305.

The control unit 300 is constituted by a processor such as a CPU. The control unit 300 is a primary control apparatus that controls the action of each unit and performs various arithmetic processes.

The input unit 301 is constituted by an input apparatus such as a mouse, a keyboard, and a physical button. The input unit 301 supplies an operation signal according to a user's operation to the control unit 300. The control unit 300 controls the action of each unit on the basis of the operation signal from the input unit 301.

The output unit 302 is constituted by an output apparatus such as a display or a speaker. The output unit 302 outputs video, audio, and the like under the control of the control unit 300.

The storage unit 303 is constituted by a storage apparatus such as a semiconductor memory. The storage unit 303 stores various sorts of data under the control of the control unit 300.

The communication unit 304 is constituted by a communication module compatible with wireless communication or wired communication complying with a predetermined standard. The communication unit 304 communicates with another device via the network 50 under the control of the control unit 300.

The service database 305 is a database in which data for providing a service that allows the user to use a variety of network services (content services and the like) using various devices is saved. Note that, although details will be described later, a management table in which a device, a user, a content service, and profile information are linked with each other is saved in the service database 305.

Furthermore, the control unit 300 includes a DB management unit 311, a learning unit 312, and an identification unit 313.

The DB management unit 311 manages data saved in the service database 305.

The learning unit 312 performs machine learning on the basis of input information (learning data) and outputs a result of the performed machine learning.

The identification unit 313 performs identification (determination, prediction, or the like) of input information on the basis of the input information and a result of the machine learning.

(Configuration of Authentication Server)

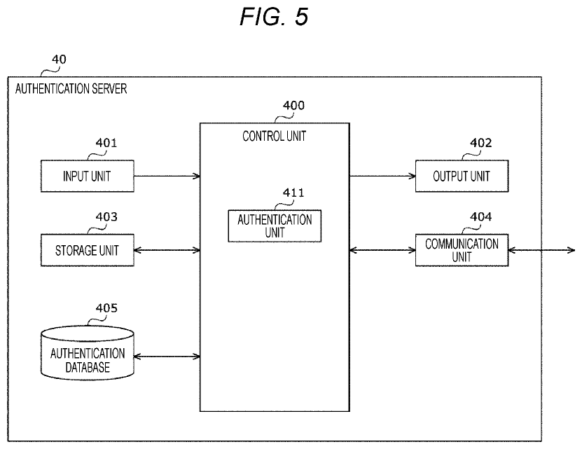

FIG. 5 illustrates an example of the configuration of the authentication server 40 in FIG. 1 as an embodiment of the information processing apparatus to which the present technology is applied.

In FIG. 5, the authentication server 40 is constituted by a control unit 400, an input unit 401, an output unit 402, a storage unit 403, a communication unit 404, and an authentication database 405.

The control unit 400 is constituted by a processor such as a CPU. The control unit 400 is a primary control apparatus that controls the action of each unit and performs various arithmetic processes.

The input unit 401 is constituted by an input apparatus such as a mouse and a keyboard. The input unit 401 supplies an operation signal according to a user's operation to the control unit 400. The control unit 400 controls the action of each unit on the basis of the operation signal from the input unit 401.

The output unit 402 is constituted by an output apparatus such as a display or a speaker. The output unit 402 outputs video, audio, and the like under the control of the control unit 400.

The storage unit 403 is constituted by a storage apparatus such as a semiconductor memory. The storage unit 403 stores various sorts of data under the control of the control unit 400.

The communication unit 404 is constituted by a communication module compatible with wireless communication or wired communication complying with a predetermined standard. The communication unit 404 communicates with another device via the network 50 under the control of the control unit 400.

The authentication database 405 is a database in which data (collation information or the like) for authenticating the user is saved.

Furthermore, the control unit 400 includes an authentication unit 411. The authentication unit 411 collates input authentication information with the collation information to perform an authentication process and outputs a result of the performed authentication.

Here, the authentication information is information for identifying the user, such as biometric information of the target user including a face image, a fingerprint, and a voiceprint, forwarded from the UI device 20 or the like via the network 50 and is collated with the collation information saved in the authentication database 405, whereby the authentication process for face authentication, fingerprint authentication, voiceprint authentication, or the like is performed.

The content reproduction system 1 is configured as described above.

Note that the configuration described above is an example of the configuration of the content reproduction system 1, and other configurations may be adopted, for example, by integrating devices (the functions of devices) together or adding another device.

For example, in the above-described configuration, the service providing server 30 and the distribution server 31 have been described as different servers, but the service providing server 30 and the distribution server 31 may be the same server. That is, this server will provide both of the management function for the management table and the distribution function for the communication content.

Furthermore, in a case where the above-described configuration is adopted, the service providing server 30 may acquire information regarding the communication content to be distributed from a plurality of distribution servers 31 and mediate the connection between the television receiver 10 and the distribution servers 31 on the basis of an operation on the UI device 20 or data saved in the management table. Moreover, the service providing server 30 itself may function as a distribution server compatible with a plurality of content services.

In addition, in the above-described configuration, a case where the television receiver 10 and the UI device 20 are provided in the home of a certain user has been exemplified, but the television receiver 10 and the UI device 20 can be similarly provided in the home of another user. That is, although only one set of the television receiver 10 and the UI device 20 is illustrated in FIG. 1 for clearer description, a plurality of sets of the television receivers 10 and the UI devices 20 can be provided such that these devices are connected to the service providing server 30, the distribution server 31, or the authentication server 40 via the network 50 and provided with various services.

In the following description, content such as broadcast content and communication content is simply referred to as content in a case where it is not particularly necessary to distinguish between these kinds of content. In other words, in the following description, a case where the present technology is applied to the communication content will be mainly described, but the present technology is also applicable to other kinds of content such as the broadcast content and recorded video content.

(Overview of System)

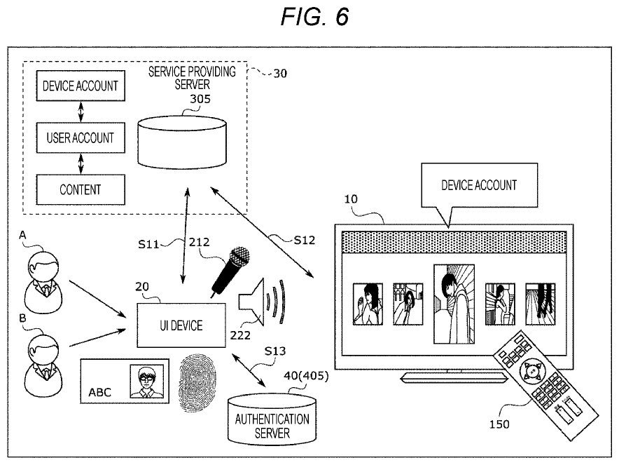

FIG. 6 illustrates an overview of a process carried out by the content reproduction system 1.

In FIG. 6, the service providing server 30 links at least a device account, a user account, and information regarding content using the management table saved in the service database 305. In other words, it can also be said that these pieces of information form link information linked by the management table. Note that, although details will be described later, the link information can include profile information regarding the profile of the user.

The device account is information for specifying a device such as the television receiver 10. As this device account, an account of an operating system (OS) or the like activated on the device may be used, in addition to allocating a unique value in accordance with a predetermined rule.

The user account is information for specifying the user. As this user account, information such as an e-mail address or a mobile phone number can be used.

The information regarding content is information for specifying content distributed by a content service (network service) such as a moving image distribution service.

However, although a case where the user account is linked with the content is illustrated here, the user account may be linked with a content service such as a moving image distribution service that distributes the content. For example, by including an account for using the content service as the user account, the user account can be linked with the content service together with content provided by this content service.

Here, for example, a case where the UI device 20 is operated by a user A among users A and B, and content reproducible on the television receiver 10 is selected is assumed. Note that, in the UI device 20, the accessibility can be enhanced by supporting voice operation with the microphone 212 and the speaker 222.

In this case, the service providing server 30 causes the UI device 20 to cooperate with the television receiver 10 on the basis of the management table (link information) saved in advance in the service database 305 (S11 and S12).

Furthermore, at this time, by sending the identification information (biometric information such as a face image, a fingerprint, and a voiceprint) of the user A from the UI device 20 to the authentication server 40 as the authentication information, the authentication server 40 carries out the authentication process (a process for face authentication, fingerprint authentication, voiceprint authentication, or the like) for the user A (S13). Then, in the television receiver 10, the content as the selected target is reproduced according to the authentication result for the user A.

For example, a case where the user A operates an application (moving image application) for a moving image distribution service on the own UI device 20 such as the smartphone of the user A and instructs the application to reproduce content such as a movie or a drama on the television receiver 10 is assumed. At this time, automatic authentication of the user A is performed (by way of the authentication server 40), and the content instructed to be reproduced is reproduced (or information regarding the reproduction of the content is displayed) by the moving image application on the television receiver 10 linked with the information of the authenticated user A by the management table.

As described above, in the content reproduction system to which the present technology is applied, inter-device cooperation between the television receiver 10 and the UI device 20 is unnecessary, and the respective devices are caused to cooperate by the link information managed in the service database 305 (the management table of the service database 305) via the service providing server 30. In other words, the television receiver 10 and the UI device 20 do not directly cooperate but cooperate via the service providing server 30 (the link information managed by the service providing server 30) in an indirect manner.

With this cooperation, in a case where one television receiver 10 is shared by a plurality of users, a difficulty that only one user can register the user account no longer occurs, and additionally, complicated operations such as frequent switching of the user accounts by, for example, login and logout every time for each service are not necessary. Consequently, the convenience of the user can be improved.

Furthermore, the current inter-device cooperation is on the supposition of cooperation with a rendering function of another device, and the UI device needs to set a dedicated connection for the inter-device cooperation, which is complicated and causes a disadvantage of instability due to the wireless environment. However, in the content reproduction system to which the present technology is applied, the inter-device cooperation between the television receiver 10 and the UI device 20 is unnecessary, and thus, such a disadvantage can be avoided.

Note that, although a case where the device account is used as the information for specifying the device such as the television receiver 10 has been indicated in the configuration in FIG. 6, other device information such as an application account and a plug-in ID may be used.

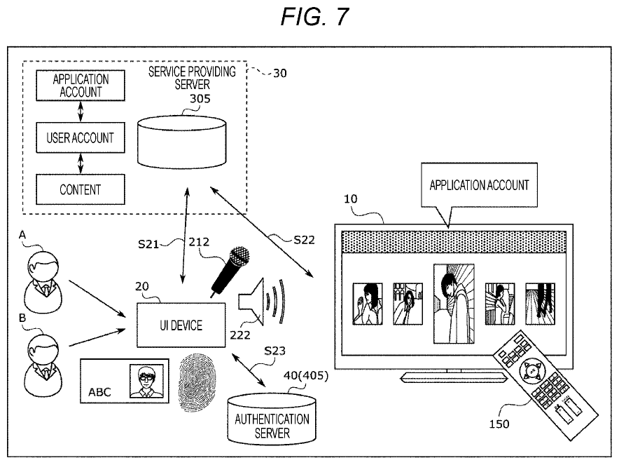

FIG. 7 illustrates a configuration in a case where the application account is used. In FIG. 7, the application account, the user account, and content (content service) are linked by the management table.

The application account is an account for using an application (an application for a content service, such as a moving image application) executed on a device such as the television receiver 10.

In the configuration in FIG. 7, the television receiver 10 and the UI device 20 are caused to cooperate by the service providing server 30 on the basis of the link information containing this application account (S21 and S22), and content selected from the UI device 20 is reproduced on the television receiver 10 according to the authentication result (S23) for the target user.

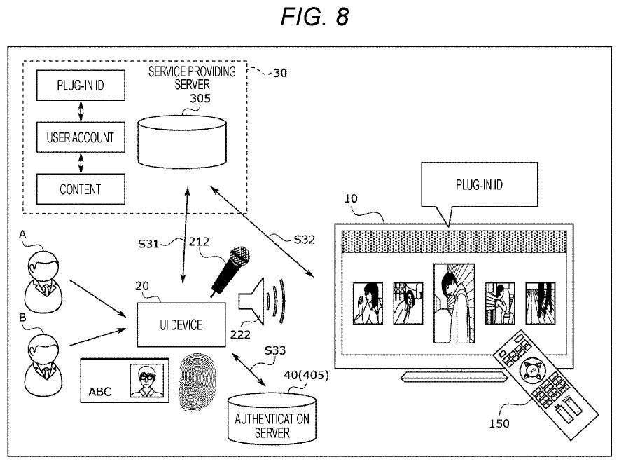

Furthermore, FIG. 8 illustrates a configuration in a case where the plug-in ID is used. In FIG. 8, the plug-in ID, the user account, and content (content service) are linked by the management table.

The plug-in ID is information for specifying a module of software executed by a device such as the television receiver 10. For example, the plug-in ID corresponds to a key for using a specific service. That is, in a case where the user purchases a specific service, the user is given a corresponding plug-in ID and can be provided with the purchased service. However, without the plug-in ID, the user can be provided with only a part of functions such as a trial service.

In the configuration in FIG. 8, the television receiver 10 and the UI device 20 are caused to cooperate by the service providing server 30 on the basis of the link information containing this plug-in ID (S31 and S32), and content selected from the UI device 20 is reproduced on the television receiver 10 according to the authentication result (S33) for the target user.

(Another Example of Account)

Incidentally, the application account can include another account in addition to the above-described account for using the content service such as a moving image distribution service.

Here, in a case where, for example, a plurality of users shares a device, an account for recommendation for recommending content to the user, an account for activity recording for recording an activity history of the user, a sub-account for the main account, or the like can be included together with an account for subscription according to contract contents of the user.

Furthermore, an account for each user according to each of these functions and a sub-account for each user may be created from the UI device 20 or may be created from the television receiver 10. These accounts may be automatically created by a registration process for the UI device 20 with respect to each content service, which will be described later.

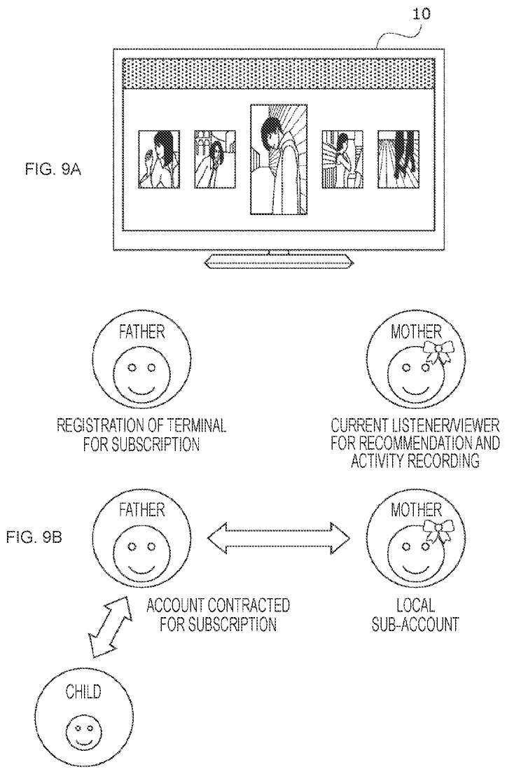

FIG. 9 illustrates an example of management of accounts in a case where a plurality of users shares a device.

A of FIG. 9 illustrates a case where the television receiver 10 is shared by all members of a certain family, and an account for subscription (subscription account) and an account for recommendation (recommendation account) are separated.

Specifically, in a case where the father registers the television receiver 10 as a terminal for subscription to a moving image distribution service, usually, recommendation information on an item or the like according to content to be recommended to the father is presented when this moving image distribution service is used.

At this time, assuming a case where the mother uses the moving image distribution service, there is a possibility that a recommendation not related to the activity history (the operation history, the listening and viewing history, and the like) of the mother is recommended because recommendation information for the father is presented.

Thus, here, by preparing a recommendation account for the mother apart from the subscription account and linking the activity history such as the operation history by the mother with the prepared recommendation account, recommendation information on an item or the like according to content to be recommended suitably for the mother (the activity history of the mother) can be presented.

Furthermore, B of FIG. 9 illustrates a case where a sub-account for the main account is linked with the subscription account as the main account in a case where the television receiver 10 is shared by all members of a certain family.

Specifically, in a case where the father makes a contract for a moving image distribution service and uses the subscription account, local sub-accounts of the subscription account are made available to the mother and a child. In this manner, by linking another account with the main account, it is possible to balance a pay subscription service belonging to an individual and a shared device used by a plurality of users.

The account for each user according to each of these functions and the sub-account for each user may be linked with the user accounts and automatically switched according to the authentication result by way of the UI device 20, or may be automatically switched by identifying the user as a function of the television receiver 10 in a case where the user directly operates the television receiver 10 to reproduce content.

In addition, information (control information) acquired by the television receiver 10 by way of the service providing server 30 may contain a part or the whole of the identification information of the user acquired by the UI device 20. This enables appropriate management of information recorded in the service database 305 in a case where a plurality of users operates the shared device.

Furthermore, in a case where, for example, the television receiver 10 is in an offline state and an operation for reproducing the downloaded content or the like is performed not by way of the authentication server 40, by automatically or manually switching the account, appropriate information can be provided to the service providing server 30 when the television receiver 10 is put into an online state again.

As described above, in the content reproduction system 1, the television receiver 10 receives the control information from a device associated with a network service (a content service such as a moving image distribution service) and presents presentation information regarding a network service designated by the control information on the basis of an identification result for a user who uses the device.

The control information is information for causing a certain device to perform a process of presenting the presentation information regarding a network service. The presentation information includes at least one of video or audio of content (a moving image such as a movie or a drama, a musical work, or the like) to be reproduced, or the recommendation information on an item or the like according to content to be recommended.

Here, for example, assuming a case where the UI device 20 accepts an operation from the user and causes the television receiver 10 to present the presentation information according to the accepted operation of the user, the above-described “device associated with a network service” is the UI device 20.

In this case, the UI device 20 acquires the identification information (authentication information or the like) of the user, generates the control information for causing the television receiver 10 to perform the process of presenting the presentation information, and sends each of the identification information and the control information (or the control information containing the identification information) to the authentication server 40 and the service providing server 30 via the network 50. However, as will be described later, in a case where the authentication process is performed by a device other than the authentication server 40, it is only required to send the identification information (authentication information or the like) to this device.

Then, the television receiver 10 receives the control information sent via the network 50 by way of the service providing server 30 and presents the presentation information regarding a network service designated by the sent control information on the basis of an identification result (authentication result) for the user who uses the UI device 20.

Furthermore, for example, assuming a case where the user directly operates the television receiver 10, that is, a case where the television receiver 10 also functions as the UI device 20, the above-described “device associated with a network service” is the television receiver 10.

In this case, the television receiver 10 sends the control information to the service providing server 30 via the network 50 according to the operation of the user and receives the control information sent from the service providing server 30 in response to the sent control information.

Then, the television receiver 10 acquires the identification information (authentication information or the like) for identifying the user and performs a process designated by the received control information such as switching between a first account and a second account on the basis of an identification result (authentication result) for the user.

In this account switching process, for example, switching between the first account (such as the subscription account) for reproducing content associated with the content service and the second account (such as the recommendation account or the sub-account) associated with the first account is performed.

That is, it can be said that the television receiver 10 presents the presentation information on the basis of the result of the authentication process for the user who uses the television receiver 10 with respect to the network service, which is performed on the basis of the identification information acquired by the television receiver 10. Furthermore, at this time, the control information received by the television receiver 10 can contain information regarding the result of the identification of the user performed on the basis of at least one piece of information among information regarding a face image, a fingerprint, and a voiceprint of the user.

Hereinafter, flows of processes executed in each apparatus constituting the content reproduction system 1 will be described.

### First Example

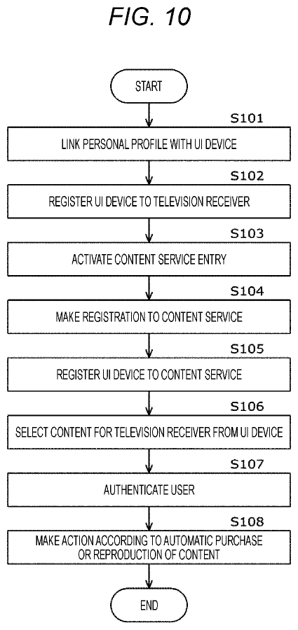

First, a flow of a first example of a content reproduction process executed by the content reproduction system 1 will be described with reference to the flowchart in FIG. 10.

In the content reproduction system 1, when content distributed by a content service such as a moving image distribution service is reproduced, processes in steps S101 to S105 are executed beforehand.

That is, a personal profile of the user is linked with the UI device 20 (S101). This linked information is also linked with each of the television receiver 10 and the content service.

Specifically, the UI device 20 is registered to the television receiver 10 (S102). Furthermore, in this UI device 20, a content service entry is activated (S103). Then, by registering various sorts of information to the content service (S104), the UI device 20 is registered to the content service (S105).

With these processes, in the service providing server 30, a management table saved in the service database 305 is generated.

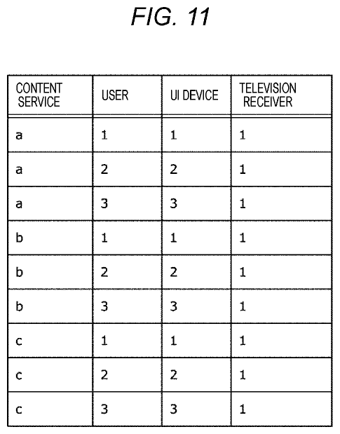

FIG. 11 illustrates an example of the management table.

In this example of the management table, information that specifies the content services (a, b, and c), information that specifies the users (1, 2, and 3), information that specifies the UI devices 20 (1, 2, and 3), and information that specifies the television receiver 10 (1 for all) are linked with each other. In different terms, the content service, the user, and the device are linked by this link information.

That is, this example of the management table indicates that different users (such as the father, the mother, and the child) are each registered to each content service (such as a moving image distribution service), and the respective users possess different UI devices 20 (such as smartphones) separately but use one television receiver 10 (the television in the living room) in common.

Furthermore, the television receiver 10 itself may be linked with the user account as the UI device 20, which enables appropriate management of information on a user who uses content (content service) only in the television receiver 10 in the same management table.

Moreover, since it is conceivable that a plurality of users uses the same content service (such as a moving image distribution service), in that case, a plurality of users will be linked with, for example, a certain content service a.

Here, in a case where the information that specifies the television receiver 10 is the application account, the above-described subscription account, recommendation account, local sub-account, and the like can be linked with the user account.

This allows the management table in the service database 305 to be appropriately managed in a case where the user directly operates a shared device such as the television receiver 10. In this case, the information that specifies the television receiver 10 does not need to equally have the same value for each user and may have, for example, values (such as 1-1, 1-2, and 1-3) indicating different accounts on the same device.

Moreover, the same user may use a plurality of different UI devices 20, and the information that specifies the UI devices 20 having different values may be linked with the information that specifies the user in the management table.

Furthermore, data of the management table saved in the service database 305 is subjected to hashing or encryption using a predetermined algorithm and is concealed.

Note that, although not illustrated, in the authentication server 40, the collation information used in the authentication process is saved in the authentication database 405. This collation information is information to be collated with the authentication information of each user during the authentication process.

Returning to the description of FIG. 10, thereafter, when content of the content service reproducible on the television receiver 10 is selected from the UI device 20 according to the operation (voice operation or the like) of the user (S106), the user is authenticated (S107).

In this authentication process, by sending the identification information of the target user from the UI device 20 to the authentication server 40 as the authentication information, the authentication server 40 collates the authentication information with the collation information, and the target user is authenticated. Specifically, the authentication process for face authentication, fingerprint authentication, voiceprint authentication, and the like is performed.

Then, the television receiver 10 makes an action according to the automatic purchase of the content as the selected target or the reproduction of the content as the selected target, according to the authentication result for the user (S108).

Here, the content as the selected target according to the operation on the UI device 20 is reproduced by the television receiver 10 on the basis of the management table (the link information saved in the management table) managed by the service providing server 30.

Note that, in the automatic purchase of the content, a settlement function of the UI device 20 such as a smartphone can be used, and the reproduction of the content may be started after the automatic purchase is confirmed. This allows the user to listen to and view the desired content selected from the UI device 20 on the television receiver 10.

As described above, in the content reproduction system 1, by registering the link information in advance on the side of the service providing server 30, in a case where desired content is requested by the user with a voice operation or the like for the UI device 20, the UI device 20 cooperates with the television receiver 10 on the basis of the authentication result for the user and the registered link information, and the desired content is reproduced.

This allows each user (such as the father) to listen to and view desired content on the television receiver 10 only by operating the UI device 20 (such as the smartphone possessed by each user) without performing a special operation (such as an operation of logging in to a target content service), even in a case where one television receiver 10 (the television in the living room) is shared by a plurality of users (family members). Therefore, an operation such as frequent switching of the user accounts is unnecessary, and the convenience of the user can be improved.

Furthermore, since the data of the management table saved in the service database 305 is subjected to hashing or encryption, security is enforced, and personal information of the user can be protected more reliably. Moreover, since the UI device 20 such as a smartphone also supports voice operation, access to content is simple. In addition, since the authentication process can be performed using functions included in the device, such as a camera function and a fingerprint authentication function, the authentication can be easily performed without involving a complex operation.

### Second Example

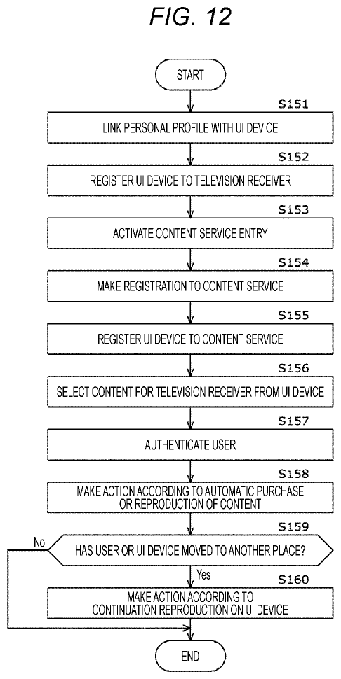

Next, a flow of a second example of the content reproduction process executed by the content reproduction system 1 will be described with reference to the flowchart in FIG. 12.

In steps S151 to S155, a management table saved in the service database 305 is generated similarly to steps S101 to S105 in FIG. 10.

Furthermore, in steps S156 to S158, similarly to steps S106 to S108 in FIG. 10, when content is selected from the UI device 20 by a user's operation, the content as the selected target is reproduced on the television receiver 10 according to the authentication result for the user.

At this time, a case where the user who is listening to and viewing the content or the UI device 20 moves to another place in a case where the content is being reproduced by the television receiver 10 is assumed. In this case, when it is detected that the user or the UI device 20 has moved to another place on the basis of the sensing data or the like (“Yes” in S159), an action according to continuation reproduction is made by the UI device 20, and the reproduction of the content being listened to and viewed is maintained (S160).

In this manner, even in a case where the user moves in the middle of listening to and viewing the content on the television receiver 10, the user can listen to and view the continuation of the content in the middle of listening and viewing on the UI device 20 such as a smartphone at the movement destination.

As described above, in the second example, in a case where the UI device 20 is operated by the user and desired content is requested, the desired content is reproduced on the television receiver 10 on the basis of the link information registered in advance, when the authentication of the user is successful.

Then, in a case where it is detected that the user who is listening to and viewing the content has moved to another place, the continuation listening and viewing of the content is performed on the UI device 20 being carried. In this manner, since the UI device 20 such as a smartphone is not dependent on locations as compared with the television receiver 10, portability for continuation listening and viewing or the like of the content can be ensured.

### Third Example

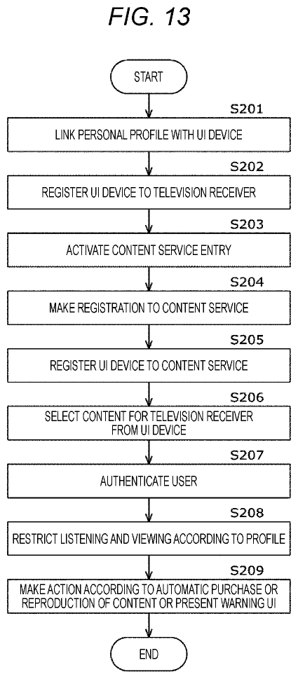

Next, a flow of a third example of the content reproduction process executed by the content reproduction system 1 will be described with reference to the flowchart in FIG. 13.

In steps S201 to S205, a management table saved in the service database 305 is generated similarly to steps S101 to S105 in FIG. 10.

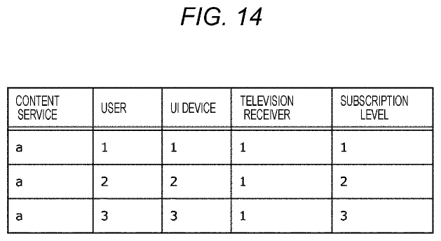

However, in the third example, as illustrated in FIG. 14, in addition to the items regarding the content service, the user, the UI device 20, and the television receiver 10, an item for a subscription level is added as the item name of the management table, and the reproduction (listening and viewing) of the content can be restricted according to restrictions regarding a service of a subscription approach.

In different terms, this subscription level is restriction information for restricting the content under a predetermined condition, and profile information containing the restriction information such as the subscription level is linked in the management table together with the content service, the user, and the device.

The subscription level may be associated with, for example, the type of the application account and the presence or absence of the plug-in ID described above.

That is, in this example of the management table, different users (such as the father, the mother, and the child) are separately registered to the content service (such as a moving image distribution service), but the subscription levels (such as 1, 2, and 3) according to the contract contents or the like are set as the profile information for each user, and the available functions, periods, and the like are different.

Returning to the description of FIG. 13, in steps S206 and S207, similarly to steps S106 and S107 in FIG. 10, when content is selected from the UI device 20 by a user's operation, this user is authenticated.

Then, in a case where the authentication of the user is successful, the television receiver 10 restricts the reproduction (listening and viewing) of the content according to the restriction information contained in the management table (the profile information in the management table) saved in the service database 305 (S208).

Specifically, in a case where the content as the selected target does not conform to the subscription level of the target user, the television receiver 10 changes the content to be reproduced according to the subscription level, and the changed content is reproduced (S209). At this time, the television receiver 10 may present a warning user interface (UI) indicating that listening and viewing are restricted according to the attribute of the profile information (S209).

Note that, here, only the warning UI may be presented such that content including the changed content will not be reproduced at all. Furthermore, in a case where the content as the selected target conforms to the subscription level of the target user and it is not necessary to restrict the listening and viewing of the content, the content as the selected target is simply reproduced as requested.

In addition, in the third example, the subscription level has been described as an example of the restriction information, but other restriction information such as restrictions regarding the age of the user, including restrictions for juveniles, may be used. Specifically, by restricting listening and viewing depending on whether or not the content as the selected target is for juveniles, it is possible to impose age restriction such as that the father and the mother are allowed to listen to and view the content but the child is not allowed to listen to and view the content.

As described above, in the third example, in a case where the UI device 20 is operated by the user and desired content is requested, listening and viewing of the content is restricted if listening and viewing restrictions are imposed when the authentication of the user is successful, on the basis of the restriction information contained in the profile information registered in advance. In this manner, listening and viewing can be restricted individually for each user on the basis of the profile information of each user managed on the side of the service providing server 30.

### Fourth Example

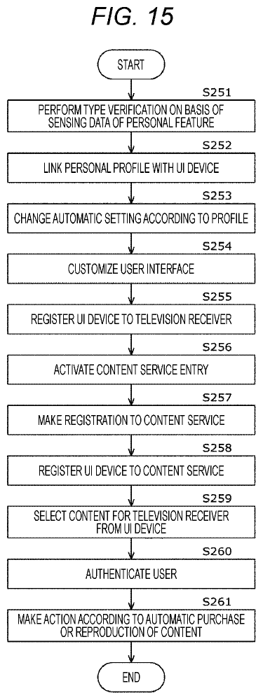

Next, a flow of a fourth example of the content reproduction process executed by the content reproduction system 1 will be described with reference to the flowchart in FIG. 15.

Here, when the management table saved in the service database 305 is generated, the type verification is performed on the basis of the sensing data of a personal feature of the user (S251).

Furthermore, the personal profile containing the result of this type verification is linked with the UI device 20 (S252), and the automatic setting is changed according to this profile (S253).

Then, the user interface is customized according to the profile information containing the personal feature (type information) such as the disability level (S254).

In addition, in steps S255 to S258, a management table saved in the service database 305 is generated similarly to steps S102 to S105 in FIG. 10.

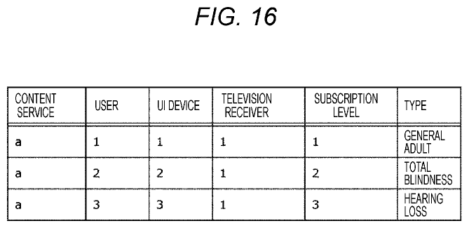

However, in the fourth example, as illustrated in FIG. 16, in addition to the items regarding the content service, the user, the UI device 20, and the television receiver 10, items for the subscription level and the type are added as the item names of the management table, and a user interface corresponding to the personal feature such as the disability level can be provided.

In different terms, in this example of the management table, the profile information containing the type information such as the disability level is linked together with the content service, the user, and the device.

That is, in this example of the management table, while different users are separately registered to the content service (such as a moving image distribution service), the type information (such as a general adult, total blindness, or hearing loss) according to the disability level is registered as the profile information for each user.

Therefore, user interfaces such as an audio guide, placement of subtitles, and a gesture sensing UI can be provided individually for each user, according to the type information such as total blindness and hearing loss.

Note that, in the fourth example, the information regarding disability has been described as an example of the type information for customizing functions and services such as the user interface, but other type information such as information regarding age and gender may be used. Specifically, an interface for children can be provided to users under a predetermined age, whereas an interface for seniors can be provided to users over a predetermined age.

Returning to the description of FIG. 15, in steps S259 to S261, similarly to steps S106 to S108 in FIG. 10, when content is selected from the UI device 20 by a user's operation, the content as the selected target is reproduced on the television receiver 10 according to the authentication result for the user.

As described above, in the fourth example, when functions and services such as the user interface are provided, the user interface and the like can be customized individually for each user on the basis of the type information contained in the profile information registered in advance. This can enhance the accessibility by providing an interface and the like suitable to each user.

### Fifth Example

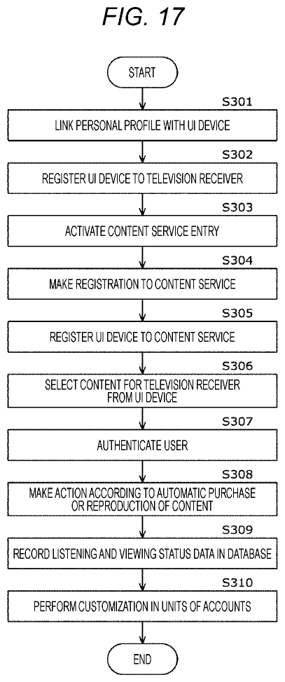

Next, a flow of a fifth example of the content reproduction process executed by the content reproduction system 1 will be described with reference to the flowchart in FIG. 17.

In steps S301 to S305, a management table saved in the service database 305 is generated similarly to steps S101 to S105 in FIG. 10.

Furthermore, in steps S306 to S308, similarly to steps S106 to S108 in FIG. 10, when content is selected from the UI device 20 by a user's operation, the content as the selected target is reproduced on the television receiver 10 according to the authentication result for the user.

At this time, the service providing server 30 records listening and viewing status data of the user in the service database 305 (S309).

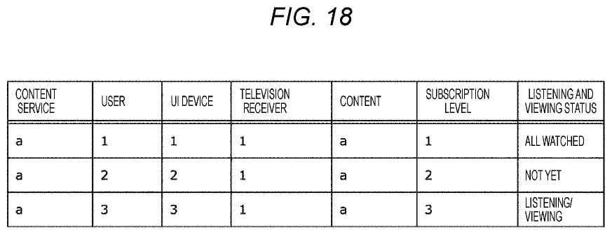

Specifically, as illustrated in FIG. 18, in the fifth example, in addition to the items regarding the content service, the user, the UI device 20, and the television receiver 10, items for the content, the subscription level, and the listening and viewing status are added as the item names of the management table, and the listening and viewing status data can be registered for each piece of content.

In different terms, in this example of the management table, the profile information containing the restriction information and listening and viewing history information is linked together with the content service, the user, and the device.

That is, in this example of the management table, while different users are separately registered to each piece of content, a history of the listening and viewing status (listening and viewing history information) such as “all watched”, “unlistened/unviewed”, and “listening/viewing” can be registered as the profile information for each piece of content. Here, more detailed information such as “listened/viewed until xx minutes and xx seconds” may be recorded.

Therefore, on the basis of this listening and viewing history information, options to be presented, that is, recommendation information on an item or the like according to content to be recommended can be changed individually for each user.

Note that the example in FIG. 18 exemplifies a case where the content and the listening and viewing history information are linked. However, in a case where a plurality of pieces of content is distributed in a content service, the listening and viewing history information can be simply registered for each of the plurality of pieces of content. Furthermore, in a case where identical pieces of content are distributed from a plurality of different content services, the listening and viewing history information for these pieces of content may be retained and used in association with each other.

Returning to the description of FIG. 17, the television receiver 10 customizes information such as options to be presented in units of accounts of the users on the basis of the listening and viewing history information contained in the management table (the profile information in the management table) saved in the service database 305 (S310).

As described above, in the fifth example, in a case where the UI device 20 is operated by the user and desired content is requested, the desired content is reproduced on the television receiver 10 on the basis of the link information registered in advance, when the authentication of the user is successful.

Furthermore, at this time, since the history of the listening and viewing status (listening and viewing history information) of each user is recorded in the service database 305, information according to the listening and viewing status can be presented for each user on the basis of this listening and viewing history information. For example, it is possible to recommend, to a certain user, content of a genre including many pieces of content with the listening and viewing status of “all watched”, or content of a genre slightly deviated from a genre including many pieces of content with the listening and viewing status of “unlistened/unviewed” rather than content of such a genre.

### Sixth Example

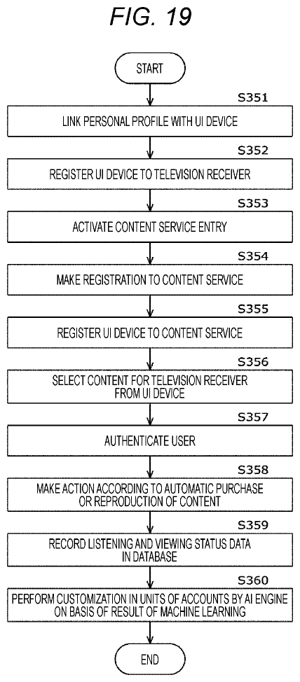

Next, a flow of a sixth example of the content reproduction process executed by the content reproduction system 1 will be described with reference to the flowchart in FIG. 19.

In steps S351 to S355, a management table saved in the service database 305 is generated similarly to steps S101 to S105 in FIG. 10.

Furthermore, in steps S356 to S358, similarly to steps S106 to S108 in FIG. 10, when content is selected from the UI device 20 by a user's operation, the content as the selected target is reproduced on the television receiver 10 according to the authentication result for the user.

Moreover, in step S359, the listening and viewing status data of the user is recorded in the service database 305, similarly to step S309 in FIG. 17.

In step S360, an AI engine executed by the identification unit 313 customizes information such as options to be presented on the television receiver 10 in units of accounts of the users on the basis of the input information and the result of the machine learning. Note that the television receiver 10 may have the function of the AI engine.

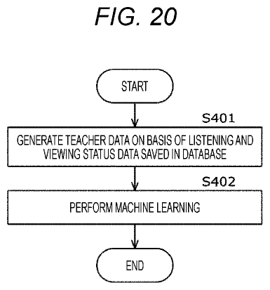

Here, the flowchart in FIG. 20 illustrates a flow of a learning process for obtaining the result of the machine learning used in the process in step S360 in FIG. 19.

In this learning process, the learning unit 312 generates teacher data on the basis of the listening and viewing status data (that is, the listening and viewing history information) in the management table (FIG. 18) saved in the service database 305 (S401) and performs the machine learning using the teacher data (S402).

As a scheme for this machine learning, for example, a neural network or deep learning is used.

The neural network is a model imitating a human cranial nerve circuit and is made up of three types of layers, namely, an input layer, an intermediate layer (hidden layer), and an output layer. Furthermore, the deep learning is a model using a neural network having a multilayer structure and can learn a complex pattern latent in a large amount of data by repeating learning distinctive for each layer.

In addition, the problem setting for machine learning includes supervised learning, unsupervised learning, semi-supervised learning, reinforcement learning, reverse reinforcement learning, active learning, transfer learning, and the like. In the sixth example, a case where the supervised learning is used is exemplified. In the supervised learning, a feature amount is learned on the basis of given labeled learning data (teacher data). This makes it possible to derive a label of unknown data.

As described above, in the sixth example, in a case where the UI device 20 is operated by the user and desired content is requested, the desired content is reproduced on the television receiver 10 on the basis of the link information registered in advance, when the authentication of the user is successful.

Furthermore, at this time, the history of the listening and viewing status (listening and viewing history information) of each user is recorded in the service database 305, and the machine learning is performed on the basis of the listening and viewing history information. Then, on the basis of the result of this machine learning, information according to the listening and viewing status can be presented for each user. Here, since the result of the machine learning is used in the presentation of the information, more precise information can be presented as more pieces of the listening and viewing history information used as the teacher data are obtained.

<2. Modifications>

(Other Configurations)

In the above description, a configuration in which the dedicated authentication server 40 is provided in the content reproduction system 1 has been indicated, but the authentication process may be performed by another device.

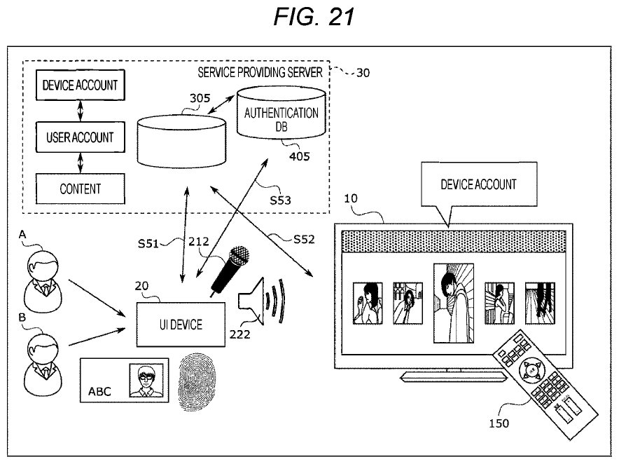

As illustrated in FIG. 21, the authentication database 405 may be provided in the service providing server 30 such that the authentication process is performed on the side of the service providing server 30.

In the configuration in FIG. 21, the service providing server 30 causes the television receiver 10 and the UI device 20 to cooperate on the basis of the management table (link information) (S51 and S52), and additionally, content selected from the UI device 20 is reproduced on the television receiver 10 according to the authentication result for the target user on the side of the service providing server 30 (S53).

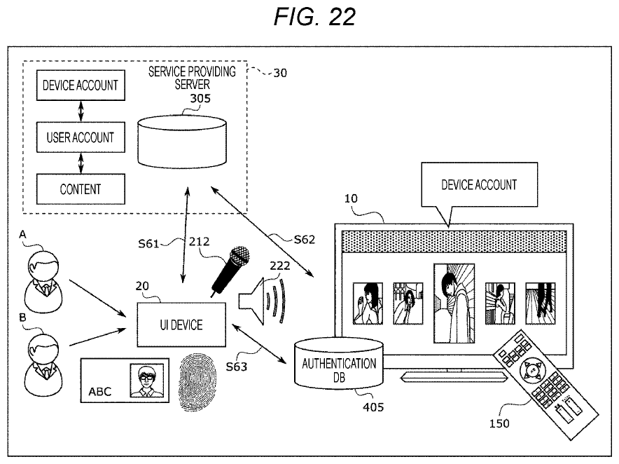

Furthermore, as illustrated in FIG. 22, the authentication database 405 may be provided in the television receiver 10 such that the authentication process is performed on the side of the television receiver 10.

In the configuration in FIG. 22, the service providing server 30 causes the television receiver 10 and the UI device 20 to cooperate on the basis of the management table (link information) (S61 and S62), and additionally, content selected from the UI device 20 is reproduced on the television receiver 10 according to the authentication result for the target user on the side of the television receiver 10 (S63).

In addition, in the content reproduction system 1, it is arbitrary which apparatus includes an element (control unit) constituting each apparatus (information processing apparatus) of the television receiver 10, the UI device 20, the service providing server 30, and the authentication server 40. For example, the control unit 100 (FIG. 2) of the television receiver 10 may have the function of the control unit 300 (FIG. 3) of the service providing server 30, or conversely, the control unit 300 (FIG. 3) of the service providing server 30 may have the function of the control unit 100 (FIG. 2) of the television receiver 10.

Moreover, the control unit 100 (FIG. 2) of the television receiver 10 may have some or all of the functions of the control unit 200 (FIG. 3), the control unit 300 (FIG. 4), and the control unit 400 (FIG. 5). Furthermore, the function of the UI device 20 may be included in the function of the television receiver 10 as an agent (such as a software agent or the like having a function in which a computer automatically determines and performs a process in accordance with a voice input). In addition, in the above description, the television receiver 10 has been described as a commonly used device, but another device may be targeted.

For example, instead of the television receiver 10, a game machine, a set-top box (STB), or the like connected to a display apparatus (not illustrated) may be used as a commonly used device. In this case, the game machine or the set-top box will perform communication with the service providing server 30 and the authentication server 40, an output process for communication content received from the distribution server 31 to the display apparatus, and the like.

Furthermore, in a case where the television receiver 10 has the function of the UI device 20, for example, information indicating the whole television receiver 10 or a part of the function that the television receiver 10 has, such as an agent function, may be saved in an item regarding the UI device in the management table in FIG. 11.

In this case, for example, in a case where the television receiver 10 is commonly used, a UI device (for example, the television receiver 10) common to a plurality of users is linked in the management table, and information is appropriately managed according to each user, using the identification information (authentication information) acquired by a microphone or a sensor unit equipped in the principal body of the television receiver 10 or the remote controller 150 of the television receiver 10, in response to a user's operation.

Note that, the system refers to a collection of a plurality of constituent elements (e.g., apparatuses and modules (components)) and whether or not all the constituent elements are arranged within the same cabinet is not regarded as important. Accordingly, a plurality of apparatuses accommodated in separate cabinets so as to be connected to one another via a network and one apparatus of which a plurality of modules is accommodated within one cabinet are both deemed as systems.

Furthermore, it is also arbitrary what communication form each constituent element has. In different terms, each constituent element may be connected via a communication network such as the Internet, an intranet, or a mobile phone network and additionally, may be connected via a local network (a local area network (LAN) or a wide area network (WAN)) or the like, as the network 50. Moreover, each of the constituent elements may be connected by wire or wirelessly.

(Method for Specifying Individual)

The activation of the content selection process (S106 in FIG. 10, S156 in FIG. 12, S206 in FIG. 13, S259 in FIG. 15, S306 in FIG. 17, and S356 in FIG. 19) described above is not limited to one specifying method using authentication of voiceprint (fingerprint), a password (keyword), or the like, and a plurality of specifying methods may be used, for example, by combining voiceprint authentication and authentication using a password.

As this plurality of specifying methods, voiceprint authentication and authentication using a gesture or biometric authentication such as fingerprint authentication by the UI device 20 such as a smartphone may be combined. Moreover, performing not only the authentication process by the authentication server 40 but also the authentication process by a plurality of devices including other devices such as the UI device 20 and the service providing server 30 can enhance the accuracy of the authentication.

(Search Procedure)

A database prepared in advance may be searched on the basis of a search condition such as an input word or sentence, and information on an item or the like according to content, which matches the search condition, may be presented. In this presentation, in a case where an error (a mistake or the like) is included in the word, a plurality of pieces of information on similar items or the like may be presented on the basis of a specific criterion.

Furthermore, in a case where there is no search result matching the search condition, the user can be notified of the fact. In this notification, an audio, a character, an icon, or the like can be used. The database for search may be saved in another device such as a remote server, as well as a device constituting the content reproduction system 1. Note that sound (artificial sound or the like) other than the user's voice can be used as the audio.

(Other Examples of User Interface)

When the user performs a voice operation, the UI interaction can be made plainer by accepting a plurality of voice commands at a time. Furthermore, in a case where voice commands having a plurality of different voiceprints are input, a plurality of media may be presented at the same time. Here, in a case where a plurality of media is presented at the same time, the plurality of media may be presented by dividing the display region such that the number of divided display regions is equal to the number of the plurality of voice inputs.

In addition, in a case where the surrounding environmental sound is loud, whether or not a voice command can be accepted may be presented. Here, in presenting whether or not the voice command can be accepted, these presentation methods such as a method of outputting by audio from a speaker and a method of displaying on a display may be selectively decided by the user in advance.

Note that, when the presentation method is selected, what presentation method to use may be selected (automatically) according to a personal feature of the user registered in advance. Alternatively, when the presentation method is selected, a personal feature of the user may be detected each time, and what presentation method to use may be selected (automatically) without setting beforehand.

(Method for Presenting Item)

A notification of the recommendation information on an item or the like presented by recommendation may be made from the UI device 20 by audio, vibration, or the like. Here, the recommendation information may be forwarded by an electronic mail, various messages, social media such as a social networking service (SNS), or the like. Furthermore, the recommendation information may be output as audio from headphones or earphones connected to the UI device 20 or the like.

In addition, the recommendation information on an item or the like presented by recommendation may be separated into two or more groups under a specific condition. Moreover, the recommendation information may be separated into subcategories.

(Method for Reflecting History)

User history information including the listening and viewing history information may have a correlation with search history information. Furthermore, the user history information may be managed as a database on the side of the service providing server 30. This database and a determination logic can be used to recommend an item or to automate service registration. Note that the determination logic has an updatable mechanism.

Here, the database is not limited to the management on the side of the service providing server 30 and may be managed by another device such as the television receiver 10 or the UI device 20. In addition, the database may ensure confidentiality by hashing and registering data. Alternatively, in the database, data may be encrypted and registered. Note that when the database is accessed via a network, confidentiality can be enhanced by using a secure protocol such as the secure sockets layer (SSL).

The determination logic may be arranged in correspondence with the history information or may be arranged by being physically put apart from the history information. Update of the determination logic may be enabled using artificial intelligence (AI). This AI may be constructed on the basis of machine learning such as a neural network or deep learning. The history information saved in the database can be used as the teacher data of this machine learning.

(Handling Complex Command during Voice Operation)

In a case where the user performs a voice operation, a complex command may be handled by registering a command set in advance as a keyword. Furthermore, even in a case where the command is shortened, a word may be selected by prediction conversion using artificial intelligence (AI). A word may be specified (automatically) by correcting fluctuations of language using a profile registered in advance.

(Method for Recommending Content)

Incidentally, when login is made using a specific user account and content is reproduced, there is desirable or undesirable content depending on a device to be used and a time period, but this cannot be reflected in recommendation based on a single profile (user profile).

For example, in a case where the UI device 20 having a small-screen display is used, content supposed to be listened to and viewed on a large-screen display such as the television receiver 10 is not desirable, and it is desirable to listen to and view short-time content in a commuting time period or the like.

Thus, the present technology proposes the following recommendation method when content is recommended.

That is, when the user logs in with the own account of the user and reproduces content on a plurality of devices, an individual profile related to each device is generated. Then, content is recommended on the basis of a profile generated in relation with a device actually used by the user for login. The above is the method. With this method, the recommendation information on an item or the like according to content to be recommended, which differs according to a device on which the network service (content service) is used, can be included as the presentation information regarding the network service.

Furthermore, when the individual profile described above is generated, the listening and viewing history of content reproduced by the user in the time period in which the user is logged in on each device can be taken into consideration. At this time, the profile can be further divided for each time period, and the listening and viewing history for each time period can be taken into consideration such that recommendation reflecting the divided profile can be performed according to the time period of login.

Note that, when the individual profile is generated, the user may be prompted to input preference information in a time period in which the user is logged in on each device.

Moreover, when the user logs in to the own account of the user and reproduces content, an individual profile related to a time period of reproduction is generated, and the content can be recommended on the basis of the profile generated in relation with the time period in which the user is logged in.

At this time, when the profiles in units of time periods are generated, the listening and viewing history of content reproduced in each time period by the user when the user is logged in can be taken into consideration. Furthermore, when the profiles in units of time periods are generated, the user may be prompted to input the preference information in units of time periods when the user is logged in.

(Other Examples of Content)

In the above description, the communication content such as a moving image streamed and distributed by the moving image distribution service has been mainly described. However, the present technology is not limited to this case and is also applicable to content such as music (musical work) streamed and distributed by a music distribution service, and Internet radio. That is, in the present technology, at least one of video or audio of the content to be reproduced or the recommendation information according to content to be recommended can be included as the presentation information regarding content. Moreover, the present technology is applicable to a variety of kinds of content including social media such as an SNS.

As described above, conventionally, in a case where a plurality of users shares one television receiver, only one user has been allowed to register an account, or it has been necessary to repeat login and logout every time for each service.

In this case, since the function of the user interface is restricted in the device used by the user, a way of use with frequent switching of accounts is considerably inconvenient, and a solution has been indicated with inter-device cooperation using a device having a function of distributing the streaming data of music or a moving image to another device.

However, the UI device is on the supposition of cooperation with a rendering function of a home device, such as listening and viewing, and it is necessary to set a dedicated connection for inter-device cooperation, which is complicated and unstable due to a wireless environment and hinders spread.

Thus, in the present technology, the inter-device cooperation is unnecessary, each device is caused to cooperate between service servers, and a database of user profiles is held on the server side. At this time, hashing or encryption (concealment) can be carried out on the database to enhance data safety.

Furthermore, a command or selection by audio may be provided as the user interface in order to facilitate authentication from the device and simplify access to content.

As a side effect, since the UI device is not dependent on locations, portability for continuation listening and viewing or the like can be ensured. In addition, since the profile is superior, listening and viewing restrictions can be individually made in the service registration setting.

<3. Configuration of Computer>

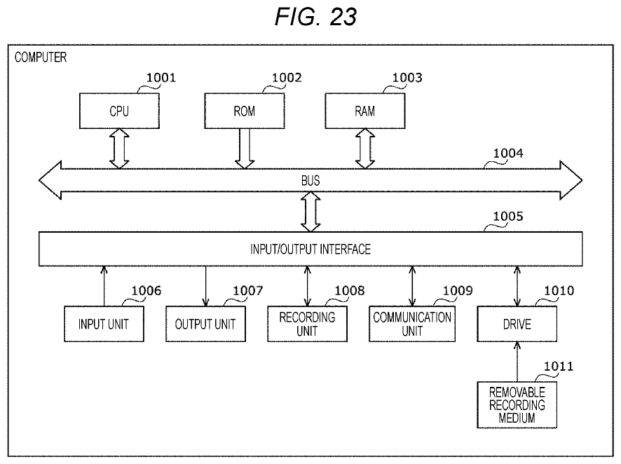

The above-described series of processes (for example, the content reproduction process illustrated in FIG. 10 and other drawings) can be executed by hardware or can be executed by software. In a case where the series of processes is executed by software, a program constituting the software is installed in a computer of each apparatus. FIG. 23 is a block diagram illustrating a hardware configuration example of a computer that executes the above-described series of processes using a program.

In the computer, a central processing unit (CPU) 1001, a read only memory (ROM) 1002, and a random access memory (RAM) 1003 are interconnected through a bus 1004. Additionally, an input/output interface 1005 is connected to the bus 1004. An input unit 1006, an output unit 1007, a recording unit 1008, a communication unit 1009, and a drive 1010 are connected to the input/output interface 1005.

The input unit 1006 includes a microphone, a keyboard, a mouse, and the like. The output unit 1007 includes a speaker, a display, and the like. The recording unit 1008 includes a hard disk, a nonvolatile memory, and the like. The communication unit 1009 includes a network interface and the like. The drive 1010 drives a removable recording medium 1011 such as a magnetic disk, an optical disc, a magneto-optical disk, or a semiconductor memory.

In the computer configured as described above, for example, the above-described series of processes is performed in such a manner that the CPU 1001 loads a program recorded in the ROM 1002 or the recording unit 1008 into the RAM 1003 via the input/output interface 1005 and the bus 1004 to execute.

For example, the program executed by the computer (CPU 1001) can be provided by being recorded in the removable recording medium 1011 serving as a package medium or the like. Furthermore, the program can be provided via a wired or wireless transmission medium such as a local area network, the Internet, or digital satellite broadcasting.

In the computer, the program can be installed to the recording unit 1008 via the input/output interface 1005 by mounting the removable recording medium 1011 in the drive 1010. In addition, the program can also be installed to the recording unit 1008 via a wired or wireless transmission medium when received by the communication unit 1009. As an alternative manner, the program can be installed to the ROM 1002 or the recording unit 1008 in advance.

Here, in the present description, the processes performed by the computer in accordance with the program do not necessarily have to be performed chronologically in the order described as the flowcharts. That is, the processes performed by the computer in accordance with the program include processes executed in parallel or individually (for example, parallel processes or processes by an object). In addition, the program may be processed by a single computer (processor), or alternatively, may be processed by a plurality of computers distributedly.

Note that the embodiments according to the present technology are not limited to the above-described embodiments and diverse changes can be made without departing from the scope of the present technology.

Furthermore, the respective steps of the content reproduction process illustrated in FIG. 10 and other drawings can be executed by a plurality of apparatuses each taking a share thereof as well as executed by a single apparatus. Moreover, in a case where a plurality of processes is included in one step, the plurality of processes included in one step can be executed by a plurality of apparatuses each taking a share thereof as well as executed by a single apparatus.

Note that the present technology can be also configured as described below.

(1)

An information processing apparatus including

a control unit that performs control to:

receive control information from a device associated with a network service; and

present presentation information regarding the network service designated by the control information on the basis of an identification result for a user who uses the device.

(2)

The information processing apparatus according to (1) above, in which

the network service includes a content service.

(3)

The information processing apparatus according to (2) above, in which

the presentation information is presented in an application related to the content service.

(4)

The information processing apparatus according to (2) or (3) above, in which

the presentation information includes at least one of video or audio of content to be reproduced, or recommendation information according to content to be recommended.

(5)

The information processing apparatus according to any one of (1) to (4) above, in which

in a case where the user or the device moves to another place, the control unit controls such that continuation of content to be reproduced is reproduced on the device.

(6)

The information processing apparatus according to any one of (1) to (5) above,

the information processing apparatus being associated with profile information of the user.

(7)

The information processing apparatus according to (6) above, in which

the profile information includes restriction information for restricting content under a predetermined condition, and

the control unit restricts reproduction of content to be reproduced on the basis of the restriction information.

(8)

The information processing apparatus according to (7) above, in which

the restriction information includes information regarding a restriction regarding a service of a subscription approach or a restriction regarding an age of a user.

(9)

The information processing apparatus according to any one of (6) to (8) above, in which

the profile information includes type information indicating a type of a user, and

the control unit changes a user interface on the basis of the type information.

(10)

The information processing apparatus according to (9) above, in which

the type information includes information regarding disability of a user or information regarding an age of a user.

(11)

The information processing apparatus according to any one of (6) to (10) above, in which

the profile information includes listening and viewing history information regarding a history of listening and viewing of content, and

the control unit presents recommendation information according to content to be recommended, on the basis of the listening and viewing history information.

(12)

The information processing apparatus according to any one of (6) to (11) above,

the information processing apparatus being linked with the device, the user, the network service, and the profile information by a management table saved in an external server, in which

the control unit performs control to receive the control information by way of the external server.

(13)

The information processing apparatus according to (2) above, in which

the control unit performs a switching process between a first account for reproducing content and a second account associated with the first account, the first account being associated with the content service, on the basis of an identification result for the user.

(14)

The information processing apparatus according to any one of (1) to (13) above, in which

the control unit

presents the presentation information on the basis of a result of an authentication process for the user with respect to the network service, the authentication process being performed on the basis of identification information acquired by the device.

(15)

The information processing apparatus according to any one of (1) to (14) above, in which

the control information is received via the Internet by way of an external server.

(16)

The information processing apparatus according to any one of (1) to (15) above, in which

the control information includes information regarding a result of identification of the user performed on the basis of at least one piece of information among information regarding a face image, a fingerprint, and a voiceprint of the user.

(17)

The information processing apparatus according to (13) above,

the information processing apparatus being the device, in which

the control unit

performs control to:

send the control information;

acquire identification information to be used for user identification for identifying a user; and

perform a switching process between the first account and the second account.

(18)

The information processing apparatus according to (4) above, in which

the presentation information includes recommendation information according to content to be recommended, which differs according to a device on which the network service is used.

(19)

An information processing apparatus

including a control unit that performs control to:

acquire identification information for identifying a user;

generate control information for causing a process of presenting presentation information regarding a network service on a device associated with the network service to be performed; and

send each of the control information and the identification information.

(20)

An information processing method including

performing, by an information processing apparatus,

control to:

receive control information from a device associated with a network service; and

present presentation information regarding the network service designated by the control information on the basis of an identification result for a user who uses the device.

### REFERENCE SIGNS LIST

1 Content reproduction system
10 Television receiver
20 UI device
30 Service providing server
31, 31-1 to 31-N Distribution server
40 Authentication server
50 Network
60 Delivering machine
100 Control unit
101 Tuner
102 Signal input unit
103 Data processing unit
104 Display
105 Speaker
106 Operation accepting unit
107 Communication unit
150 Remote controller
200 Control unit
201 Input unit
202 Output unit
203 Storage unit
204 Communication unit
205 Sensor unit
211 Button
212 Microphone
221 Display
222 Speaker
300 Control unit
301 Input unit
302 Output unit
303 Storage unit
304 Communication unit
305 Service database
311 DB management unit
312 Learning unit
313 Identification unit
400 Control unit
401 Input unit
402 Output unit
403 Storage unit
404 Communication unit
405 Authentication database
411 Authentication unit
1001 CPU

1. An information processing apparatus comprising
a control unit that performs control to:
receive control information from a device associated with a network service; and
present presentation information regarding the network service designated by the control information on a basis of an identification result for a user who uses the device.

2. The information processing apparatus according to claim 1, wherein
the network service includes a content service.

3. The information processing apparatus according to claim 2, wherein
the presentation information is presented in an application related to the content service.

4. The information processing apparatus according to claim 2, wherein
the presentation information includes at least one of video or audio of content to be reproduced, or recommendation information according to content to be recommended.

5. The information processing apparatus according to claim 1, wherein
in a case where the user or the device moves to another place, the control unit controls such that continuation of content to be reproduced is reproduced on the device.

6. The information processing apparatus according to claim 1,
the information processing apparatus being associated with profile information of the user.

7. The information processing apparatus according to claim 6, wherein
the profile information includes restriction information for restricting content under a predetermined condition, and
the control unit restricts reproduction of content to be reproduced on a basis of the restriction information.

8. The information processing apparatus according to claim 7, wherein
the restriction information includes information regarding a restriction regarding a service of a subscription approach or a restriction regarding an age of a user.

9. The information processing apparatus according to claim 6, wherein
the profile information includes type information indicating a type of a user, and
the control unit changes a user interface on a basis of the type information.

10. The information processing apparatus according to claim 9, wherein
the type information includes information regarding disability of a user or information regarding an age of a user.

11. The information processing apparatus according to claim 6, wherein
the profile information includes listening and viewing history information regarding a history of listening and viewing of content, and
the control unit presents recommendation information according to content to be recommended, on a basis of the listening and viewing history information.

12. The information processing apparatus according to claim 6,
the information processing apparatus being linked with the device, the user, the network service, and the profile information by a management table saved in an external server, wherein
the control unit performs control to receive the control information by way of the external server.

13. The information processing apparatus according to claim 2, wherein
the control unit performs a switching process between a first account for reproducing content and a second account associated with the first account, the first account being associated with the content service, on a basis of an identification result for the user.

14. The information processing apparatus according to claim 1, wherein
the control unit
presents the presentation information on a basis of a result of an authentication process for the user with respect to the network service, the authentication process being performed on a basis of identification information acquired by the device.

15. The information processing apparatus according to claim 1, wherein
the control information is received via the Internet by way of an external server.

16. The information processing apparatus according to claim 1, wherein
the control information includes information regarding a result of identification of the user performed on a basis of at least one piece of information among information regarding a face image, a fingerprint, and a voiceprint of the user.

17. The information processing apparatus according to claim 13,
the information processing apparatus being the device, wherein
the control unit
performs control to:
send the control information;
acquire identification information to be used for user identification for identifying a user; and
perform a switching process between the first account and the second account.

18. The information processing apparatus according to claim 4, wherein
the presentation information includes recommendation information according to content to be recommended, which differs according to a device on which the network service is used.

19. An information processing apparatus
comprising a control unit that performs control to:
acquire identification information for identifying a user;
generate control information for causing a process of presenting presentation information regarding a network service on a device associated with the network service to be performed; and
send each of the control information and the identification information.

20. An information processing method comprising
performing, by an information processing apparatus,
control to:
receive control information from a device associated with a network service; and
present presentation information regarding the network service designated by the control information on a basis of an identification result for a user who uses the device.
